(19) United States
(12) Patent Application Publication
(10) Pub. No.: US 2025/0201867 A1
(43) Pub. Date: Jun. 19, 2025

(54) SEPARATOR FOR ELECTROCHEMICAL DEVICE AND ELECTROCHEMICAL DEVICE INCLUDING THE SAME

(71) Applicant: SAMSUNG ELECTRO-MECHANICS CO., LTD., Suwon-si (KR)

(72) Inventors: Seong Gu Kim, Suwon-si (KR); Jung Deok Park, Suwon-si (KR)

(73) Assignee: SAMSUNG ELECTRO-MECHANICS CO., LTD., Suwon-si (KR)

(21) Appl. No.: 18/980,998

(22) Filed: Dec. 13, 2024

(30) Foreign Application Priority Data
Dec. 14, 2023 (KR) 10-2023-0181917
Feb. 19, 2024 (KR) 10-2024-0023710

(51) Int. Cl. H01M 8/0254; C25B 9/19; C25B 13/02; H01M 8/0258; H01M 8/12

(52) U.S. Cl. CPC H01M 8/0254; C25B 9/19; C25B 13/02; H01M 8/0258; H01M 2008/1293

(57) ABSTRACT

An example embodiment of the present disclosure provides a separator for an electrochemical device including a fluid inlet, a fluid outlet, and a plurality of streamlined walls configured to provide at least a portion of a flow path connected to the fluid inlet and the fluid outlet, and at least two of the plurality of streamlined walls, including one streamlined wall closer to the fluid inlet than another streamline wall, have a shape in which straight lines connecting one end and the other end are not parallel to each other.

CROSS-REFERENCE TO RELATED APPLICATION(S)

This application claims benefit of priority to Korean Patent Application Nos. 10-2023-0181917 filed on Dec. 14, 2023 and 10-2024-0023710 filed on Feb. 19, 2024, in the Korean Intellectual Property Office, the disclosures of which are incorporated herein by reference in their entirety.

### TECHNICAL FIELD

The present disclosure relates to a separator for an electrochemical device and an electrochemical device including the same.

An electrochemical device may include a fuel cell generating electrical energy by electrochemically reacting a fuel (hydrogen) and an oxidizing agent (pure oxygen or atmospheric oxygen), an electrolysis cell generating hydrogen and oxygen through electrolysis of water, and the like.

As an example of such an electrochemical device, a solid oxide fuel cell (SOFC) and a solid oxide electrolysis cell (SOEC) include a cell comprising an air electrode, a fuel electrode, and a solid electrolyte with oxygen ion conductivity, and the cell may be referred to as a solid oxide cell. The solid oxide cell produces electrical energy through an electrochemical reaction or produces hydrogen by electrolyzing water through a reverse reaction of a solid oxide fuel cell. In addition, other types of fuel cells or water electrolytic cells, such as a phosphoric acid fuel cell (PAFC), an alkaline fuel cell (AFC), a polymer electrolyte fuel cell (PEMFC), and a direct methanol fuel cell (DMFC), are also used in one form of the electrochemical device.

For the electrochemical device, it is common to use a stack structure in which unit cells are disposed between a pair of separators. Here, a flow path through which fluid may flow is formed in the separator. Water vapor, hydrogen, oxygen gas, and the like, flow through the flow path of the separator, and the direction, speed, and flow rate of the fluid have a significant impact on the performance of electrochemical devices. Accordingly, research has recently been conducted in the field of technology to optimize the size and shape of the flow path.

### SUMMARY

An aspect of the present disclosure is to implement a separator for an electrochemical device designed to provide high performance when applied to the electrochemical device.

As a method to solve the above-described problems, the present disclosure is to propose a novel structure of a separator for an electrochemical device through an example embodiment, and specifically, the separator may include: a fluid inlet; a fluid outlet; and a plurality of streamlined walls configured to provide at least a portion of a flow path connected to the fluid inlet and the fluid outlet, and at least two of the plurality of streamlined walls, including one streamlined wall closer to the fluid inlet than another streamline wall, may have a shape in which straight lines connecting one end and the other end are not parallel to each other.

In an example embodiment, when a direction oriented from the fluid inlet to the fluid outlet is referred to as a first direction, and a direction, perpendicular to the first direction, is referred to as a second direction, at least one of the plurality of streamlined walls may include a first streamlined portion having a central axis, parallel to the first direction, and having a first protrusion portion protruding in the second direction, based on the central axis, and a second streamlined portion connected to the first streamlined portion and having a second protrusion protruding in the second direction, based on the central axis.

In an example embodiment, one end and the other end of the at least one streamlined wall may be disposed in opposite positions based on the central axis.

In an example embodiment, the first and second protrusion portions may protrude in opposite directions with respect to the central axis.

In an example embodiment, the first and second protrusion portions may have the same maximum length spaced apart from the central axis in the second direction.

In an example embodiment, at least one of one end and the other end of the at least one streamlined wall may have an angle of 30° or less, with respect to the first direction.

In an example embodiment, the at least one streamlined wall may include each of the first and second streamlined portions in plural and has a structure in which the first streamlined portions and the second streamlined portions are alternately repeated.

In an example embodiment, the at least one streamlined wall may include two each of the first streamlined portion and the second streamlined portion.

In an example embodiment, when a sum of a length of the first streamlined portion and a length of the second streamlined portion adjacent thereto based on a length in the first direction is referred to as T and a maximum length in the second direction in which the first protrusion portion or the second protrusion portion is spaced apart from the central axis is referred to as H, a condition of 8≤T/H≤12 may be satisfied.

In an example embodiment, when a direction oriented from the fluid inlet to the fluid outlet is referred to as a first direction, the plurality of streamlined walls may be arranged in the first direction.

In an example embodiment, among the plurality of streamlined walls, streamlined walls adjacent to each other in the first direction may have a symmetrical shape based on a straight line, perpendicular to the first direction.

In an example embodiment, when a direction oriented from the fluid inlet to the fluid outlet is referred to as a first direction, and a direction, perpendicular to the first direction, is referred to as a second direction, the plurality of streamlined walls may be arranged in the second direction.

In an example embodiment, based on a shape viewed from an upper portion, an area occupied by the flow path may be 70 to 80% of a total area.

In an example embodiment, the at least one streamlined wall may include one each of the first streamlined portion and the second streamlined portion.

In an example embodiment, when a sum of a length of the first streamlined portion and a length of the second streamlined portion adjacent thereto based on a length in the first direction is referred to as T and a maximum length in the second direction in which the first protrusion portion or the second protrusion portion is spaced apart from the central axis is referred to as H, a condition of 2.5<T/H≤4 may be satisfied.

In an example embodiment, the plurality of streamlined walls may be arranged in the first and second directions.

In an example embodiment, among the plurality of streamlined walls, streamlined walls adjacent to each other in the first direction may be disposed in positions shifted in the second direction.

In an example embodiment, when a second directional length of the streamlined walls adjacent to each other in the first direction, among the plurality of streamlined walls, is referred to as S1 and a second directional length of streamlined walls adjacent to each other in the second direction, among the plurality of streamlined walls, is referred to as S2, a condition of 0.4≤S1/S2≤0.6 may be satisfied.

In an example embodiment, in streamlined walls adjacent to each other in the first direction and disposed in positions shifted in the second direction, among the plurality of streamlined walls, directions in which the first protrusion portion protrudes may be opposite to each other based on the central axis.

According to another aspect of the present disclosure, provided is an electrochemical device including: a plurality of separators; and an electrochemical cell disposed between the plurality of separators, and at least one of the plurality of separators may include a fluid inlet, a fluid outlet, and a plurality of streamlined walls configured to provide at least a portion of a flow path connected to the fluid inlet and the fluid outlet, and at least two of the plurality of streamlined walls, including one streamlined wall closer to the fluid inlet than another streamline wall, may have a shape in which straight lines connecting one end and the other end are not parallel to each other.

In an example embodiment, the electrochemical device further includes: a current collector disposed between at least one of the plurality of separators and the electrochemical cell.

According to another aspect of the present disclosure, provided is a separator for an electrochemical device, and specifically, the separator may include: a fluid inlet; a fluid outlet spaced apart from the fluid inlet in a first direction; and a plurality of streamlined walls disposed in a region between the fluid inlet and the fluid outlet. A first distance in the first direction from a first streamlined wall among the plurality of streamlined walls to one of the fluid inlet and the fluid outlet may be different from a second distance in the first direction from a second streamlined wall among the plurality of streamlined walls to the one of the fluid inlet and the fluid outlet. A first inclination direction of one end of the first streamlined wall and a second inclination direction of one end of the second streamlined wall adjacent to the one end of the first streamlined wall, with respect to the first direction, may be bent with each other.

In an example embodiment, the first streamlined wall may include a first streamlined portion having a first protrusion portion protruding in a second direction and a second streamlined portion connected to the first streamlined portion and having a second protrusion protruding in the second direction, the second direction being perpendicular to the first direction.

In an example embodiment, the first and second protrusion portions may protrude in opposite directions with respect to the first direction.

In an example embodiment, the first streamlined wall may include each of the first and second streamlined portions in plural and has a structure in which the first streamlined portions and the second streamlined portions are alternately repeated.

In an example embodiment, the one end of the first streamlined wall and the end of the second streamlined wall adjacent to the one end of the first streamlined wall may be aligned in the first direction.

In an example embodiment, the one end of the first streamlined wall and the end of the second streamlined wall adjacent to the one end of the first streamlined wall may be offset in the first direction.

According to another aspect of the present disclosure, provided is an electrochemical device including: a plurality of separators; and an electrochemical cell disposed between the plurality of separators. At least one of the plurality of separators may include a fluid inlet, a fluid outlet spaced apart from the fluid inlet in a first direction, and a plurality of streamlined walls disposed in a region between the fluid inlet and the fluid outlet. A first distance in the first direction from a first streamlined wall among the plurality of streamlined walls to one of the fluid inlet and the fluid outlet may be different from a second distance in the first direction from a second streamlined wall among the plurality of streamlined walls to the one of the fluid inlet and the fluid outlet. A first inclination direction of one end of the first streamlined wall and a second inclination direction of one end of the second streamlined wall adjacent to the one end of the first streamlined wall, with respect to the first direction, may be bent with each other.

A separator for an electrochemical device according to an example embodiment of the present disclosure may provide high performance when applied to an electrochemical device.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1 and 2 schematically illustrate an appearance of a separator for an electrochemical device according to an example embodiment of the present disclosure, and correspond to a perspective view and a plan view, respectively;

FIG. 3 is an enlarged view of the streamlined wall of FIG. 2;

FIG. 4 and FIG. 5 schematically illustrate an appearance of a separator for an electrochemical device according to a modified example embodiment, and correspond to a perspective view and a plan view, respectively;

FIG. 6 and FIG. 7 schematically illustrate an appearance of a separator for an electrochemical device according to another example embodiment of the present disclosure, and correspond to a perspective view and a plan view, respectively;

FIG. 8 is an enlarged view of a partial region in FIG. 7;

FIG. 9 is an enlarged view of the streamlined wall in FIG. 7;

FIG. 10 and FIG. 11 schematically illustrate an appearance of a separator for an electrochemical device according to a modified example embodiment, and correspond to a perspective view and a plan view, respectively;

FIG. 12 and FIG. 13 schematically illustrate an appearance of a separator for an electrochemical device according to a modified example embodiment, and correspond to a perspective view and a plan view, respectively;

FIGS. 14 to 18 are results of analyzing a distribution of current density according to a shape of a wall forming a flow path in a separator using a computational fluid dynamics (CFD) model;

FIG. 19 is an analysis of a relationship between a cell voltage and current density for various types of walls;

FIG. 20 is a graph analyzing a relationship between a cell voltage and current density by varying a width of a streamlined wall and a flow path ratio in a separator according to an example embodiment of FIG. 1;

FIG. 21 is a graph analyzing a relationship between a cell voltage and current density by varying a width w of a streamlined wall and a flow path ratio in a separator according to an example embodiment of FIG. 4; and

FIG. 22 illustrates a water electrolysis device to which a separator having a streamlined wall according to an example embodiment of the present disclosure is applied.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to better explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

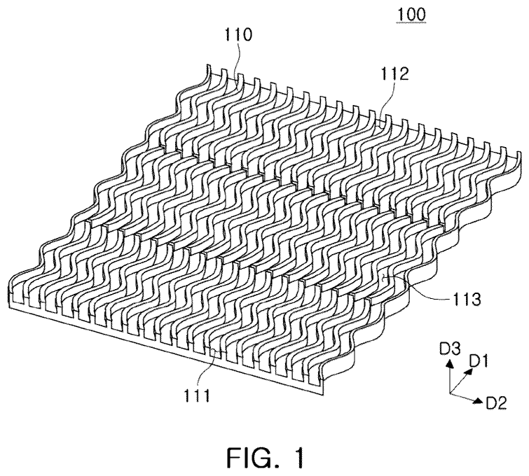

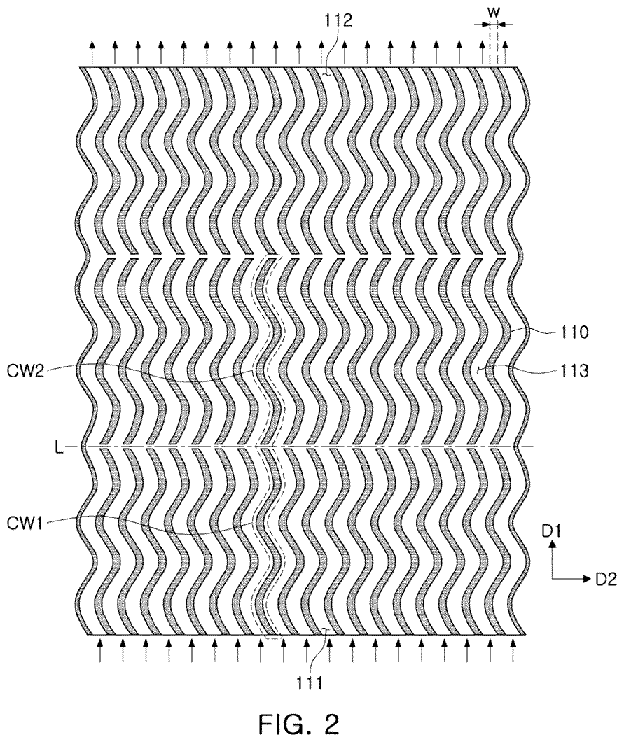

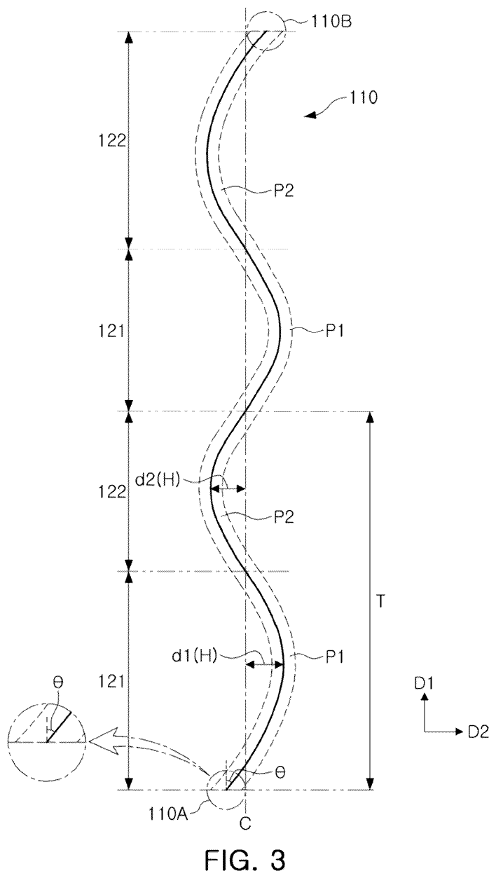

FIGS. 1 and 2 schematically illustrate an appearance of a separator for an electrochemical device according to an example embodiment of the present disclosure, and correspond to a perspective view and a plan view, respectively. FIG. 3 is an enlarged view of the streamlined wall of FIGS. 1 and 2.

A separator 100 for an electrochemical device according to an example embodiment of the present disclosure includes a fluid inlet 111, a fluid outlet 112, and a plurality of streamlined walls 110, and the streamlined wall 110 forms at least a portion of a flow path 113 connected to the fluid inlet 111 and the fluid outlet 112. Here, at least two of the plurality of streamlined walls 110 have has a shape in which straight lines connecting one end 110A and the other end 110B are not parallel to each other. To express this non-parallel structure from another aspect, at least one of the plurality of streamlined walls 110 has a structure in that a direction of the straight line connecting one end 110A and the other end 110B is not parallel to a first direction DI oriented from the fluid inlet 111 to the fluid outlet 112.

Referring to FIGS. 1 to 3, a detailed description will be given of a form in which the straight lines connecting one end 110A and the other end 110B of the plurality of streamlined walls 110 are not parallel to each other. As illustrated, when the direction oriented from the fluid inlet 111 to the fluid outlet 112 is referred to as the first direction D1, the streamlined wall 110 may include a first streamlined portion 121 and a second streamlined portion 122 having a central axis C, parallel to the first direction D1, and protruding based on the central axis C. The first and second streamlined portions 121 and 122 may be connected to each other, from which by providing the first streamlined portion 121 and the second streamlined portion 122, the streamlined wall 110 may have an overall S-shaped or similar S-shaped shape. The first streamlined portion 121 has a first protrusion portion P1 protruding in a second direction D2, perpendicular to the first direction D1, based on the central axis C parallel to the first direction D1, and similarly, the second streamlined portion 122 may have a second protrusion portion P2 protruding in the second direction D2 based on the central axis C in the first direction D1.

As described above, the first direction D1 is defined as the direction oriented from the fluid inlet 111 to the fluid outlet 112 in the separator 100, but the first direction D1 does not represent only one direction and may include both directions, that is, both upward and downward directions based on FIG. 2. Similarly, the second direction D2, perpendicular to the first direction D1, does not represent only one direction, and may include both directions, that is, a left direction and a right direction, based on FIG. 2. Similarly, a third direction D3, perpendicular to the first and second directions D1 and D2, does not represent only one direction, and may include two directions, that is, two opposite directions.

In an example embodiment, at least two of the plurality of streamlined walls 110 have a state in which the straight lines connecting one end 110A and the other end 110B are not parallel to each other, and in the illustrated shape, the streamlined walls CW1 and CW2 adjacent to each other in the first direction D1 satisfy such a condition. As a specific example of this non-parallel structure, as illustrated in FIG. 3, one end 110A and the other end 110B of the streamlined wall 110 may be disposed in opposite positions based on the central axis C. In the case of a conventional separator having a streamlined flow path, both one end and the other end of the wall are disposed on the central axis, but in the case of this example embodiment, the straight lines connecting the ends 110A and 110B of the plurality of streamlined walls 110 are not parallel to each other, and for this purpose, the positions of one end 110A and the other end 110B of the streamlined wall 110 are disposed opposite to the central axis C. This design method may make it possible to use an area of the separator 100 efficiently, so that the current density of the separator 100 may be uniform entirely. The specific shape of the streamlined wall 110 will be described below.

The separator 100 for an electrochemical device (hereinafter also referred to as a separator) may be formed of a conductive material, and when used as SOEC or SOFC, the separator 100 may include a metal having a high melting point so as not to melt or soften at high temperatures. For example, the separator 100 may be formed of a nickel-based material, an iron-based material, or a stainless-based material. Additionally, when an operating temperature of the separator 100 is relatively low, and for example, when the operating temperature is as low as 800° C. or less, copper or copper alloys having good electrical conductivity may also be used. The separator 100 includes the streamlined wall 110 to form a flow path and may include the streamlined wall 110 in plural as illustrated. In this case, the fluid inlet 111 and the fluid outlet 112 of the separator 100 do not need to be clearly distinguished from the flow path 113, and the fluid inlet 111 and the fluid outlet 112 may not be provided as additional components but may form portions of the flow path 113.

To form the streamlined wall 110 on the separator 100, for example, a metal plate may be processed using an appropriate stamping process, etching process, and the like. The separator 100 includes the fluid inlet 111 and the fluid outlet 112, and for example, when used as a water electrolysis device, water may be injected in the form of water vapor through the fluid inlet 111 and hydrogen gas may be discharged through the fluid outlet 112, and this may be the opposite when used as a fuel cell. However, the fluid inlet 111 and the fluid outlet 112 may change depending on the direction in which the fluid is injected. Hereinafter, a function of the streamlined wall 110 will be described using a case in which the separator 100 is applied to a fuel electrode side of the water electrolysis device, as a major example. In the case of the separator 100 disposed on the fuel electrode side of the water electrolysis device, water vapor and some hydrogen may be injected from the fluid inlet 111 in a direction indicated by an arrow in FIG. 2, and as the fluid flows along the separator 100, the concentration of water vapor may decrease and the concentration of hydrogen may increase. The flow path of the separator 100 may supply reactants, but may function to effectively remove products generated by the reaction by moving the products to an outlet.

As described above, at least one of the plurality of streamlined walls 110 may include a first streamlined portion 121 and a second streamlined portion 122. In the case of the streamlined wall 110, a contact area with the fluid may be increased as compared to a case of using a straight wall, thereby improving the reaction efficiency of the electrochemical device. Also, as illustrated, the streamlined wall 110 includes a plurality of first streamlined portions 121 and a plurality of second streamlined portions 122, respectively, and may have a structure in which the first streamlined portion 121 and the second streamlined portion 122 are alternately repeated.

In terms of shape, at least one of the plurality of streamlined walls 110 may have a curved surface and include a plurality of protrusion portions P1 and P2. Here, the protrusion portions P1 and P2 may be defined as regions in which lengths dl and d2 in the second direction D2 increase and then decrease. However, the protrusion portions P1 and P2 do not need to have a streamlined shape all the times, and in addition to the protrusion portions P1 and P2, a streamlined structure may appear in other regions of the streamlined wall 110. By having the plurality of protrusion portions P1 and P2, the streamlined wall 110 is implemented as a sine wave or a shape similar thereof, but the positions of one end 110A and the other end 110B are disposed in different positions based on the central axis C. The streamlined wall 110 has a three-dimensional structure, but the shape thereof may be defined based on the plan view of FIG. 2, and FIG. 3 illustrates a shape of one streamlined wall 110 in more detail. In FIG. 3, dotted lines represent an outline of the streamlined wall 110 of FIG. 2, and a solid line represents a center line of the outlines of the streamlined wall 110. In the description below, the shape or size of the streamlined wall 110 may be set based on a center line of the solid line in the streamlined wall 110.

Referring to FIG. 3, as described above, in an example embodiment, the positions of one end 110A and the other end 110B, which respectively correspond to starting and ending points of the streamlined wall 110, may be disposed in opposite positions based on the central axis C. Here, one end 110A and the other end 110B of the streamlined wall 110 are as examples, which may be determined based on the plan view of FIG. 3, and specifically, in FIG. 3, one end 110A and the other end 110B may be defined as corresponding to one end and the other end of a center line of the streamlined wall 110, respectively. Additionally, a first protrusion portion P1 of the first streamlined portion 121 and a second protrusion portion P2 of the second streamlined portion 122 may protrude in opposite directions with respect to the central axis C. Additionally, the first and second protrusion portions P1 and P2 may have the same maximum length H spaced apart from the central axis C in the second direction D2. That is, the central axis C of the streamlined wall 110 may pass through a point corresponding to centers of the first protrusion portion P1 and the second protrusion portion P2. In this case, a boundary between the first streamlined portion 121 and the second streamlined portion 122 may be determined by the central axis C, and specifically, the central axis C may pass through a point at which the first streamlined portion 121 and the second streamlined portion 122 meet.

As in this example embodiment, the positions of one end 110A and the other end 110B of the streamlined wall 110 may be disposed in opposite positions based on the central axis C, so that an overall area occupied by the streamlined wall 110 of the separator 100 may be made uniform, from which the current density in the separator 100 may be made uniform. Specifically, the separator 100 generally has a rectangular outline, and when using a wall in which one end and the other end thereof are both disposed on the central axis, that is, when all straight lines connecting one end and the other end of the wall are parallel to each other, an area in which a wall is not able to be formed in an edge region of the separator 100 increases as compared to this example embodiment, and accordingly, the uniformity of the current density in the separator 100 may deteriorate.

Additionally, in an example embodiment, one end 110A and the other end 110B of the streamlined wall 110 may be implemented in a shape having a relatively low inclination. Specifically, in at least one of one end 110A and the other end 110B of the streamlined wall 110, an angle θ formed with a direction parallel to the central axis C, that is, the first direction D1, may be 30° or less. This corresponds to a relatively low angle as compared to the fact that in a sinusoidal wall with one end and the other end disposed on the central axis, an angle at which the one end and the other end are formed with the direction parallel to the central axis is about 35°. As the inclinations of one end and the other end of the streamlined wall 110 decreases, a flow direction of the fluid passing through the streamlined wall 110 may be close to a straight line, and a pressure drop as the fluid passes through the separator 100 may be reduced by a low level (e.g., less than 1000 Pa).

The streamlined wall 110 may include a plurality of first streamlined portions 121 and a plurality of second streamlined portions 122, respectively. Here, the first streamlined portion 121 and the second streamlined portion 122 may be disposed alternately. Additionally, the streamlined wall 110 may be provided with two first streamlined portions 121 and two second streamlined portions 122, respectively. In this case, lengths of the streamlined wall 110 in the first direction D1 and the second direction D2 may be designed to provide a flow of fluid that may improve the performance of electrochemical devices. As an example, when a sum of a length of the first streamlined portion 121 and a length of the second streamlined portion 122 adjacent thereto based on the length in the first direction D1 is referred to be T, and a maximum length of the first protrusion portion P1 or the second protrusion portion P2 spaced apart from the central axis C in the second direction D2 is referred to as H, a condition of 8≤T/H≤12 may be satisfied. Here, T is a length corresponding to one cycle when the first streamlined portion 121 and the second streamlined portion 122 are repeated. When the condition of 8≤T/H≤12 is satisfied, lengths d1 and d2 of the protrusion portions P1 and P2 are relatively shorter than that of a typical sine wave, and such a condition is set to effectively induce fluid flow in an outlet direction while ensuring reactivity of a fuel fluid. As in this example embodiment, the lengths d1 and d2 of the protrusion portions P1 and P2 may be relatively shortened to reduce an influence of friction between the streamlined wall 110 and the fluid (e.g., water vapor used as fuel in a water electrolysis device). In other words, problems that may occur by lowering the pressure of the fluid and increasing the current density due to friction between the streamlined wall 110 and the fluid may be reduced.

In the separator 100, the plurality of streamlined walls 110 may be arranged in at least one of the first direction D1 and the second direction D2. FIGS. 1 and 2 illustrate a plurality of streamlined walls 110 arranged in the first direction D1 and the second direction D2. However, the plurality of streamlined walls 110 may be arranged in either the first direction D1 or the second direction D2. As in this example embodiment, the plurality of streamlined walls 110 may be adopted on the separator 100 and may be arranged in at least one of the first direction D1 and the second direction D2, thereby inducing a smooth flow of fluid as well as reducing the phenomenon of fluid concentrating in a local area. For example, when the plurality of streamlined walls 110 are arranged in the first direction D1 and the second direction D2, fluids moving in the first direction D1 through different flow paths may be mixed with a fluid adjacent thereto in the second direction D2 in a portion in which the streamlined wall 110 is broken, that is, a region in which the streamlined wall 110s are spaced apart from each other in the first direction D1, so that the pressure and speed of the fluid in the corresponding region may be made uniform. Additionally, as illustrated, an outermost region of the separator 100 (leftmost and rightmost walls based on FIG. 2) may also have a streamlined structure to correspond to the streamlined wall 110.

Among the plurality of streamlined walls 110, the streamlined walls (CW1 and CW2 indicated by dotted lines in FIG. 2) adjacent to each other in the first direction D1 may be symmetrical based on a straight line, perpendicular to the first direction D1, that is, a straight line L in the second direction D2. When the adjacent streamlined walls in the first direction D1 are arranged in the same shape, that is, as compared to a case in which the streamlined walls having the same shape are repeated in the first direction D1, as in this example embodiment, the adjacent streamlined walls CW1 and CW2 in the first direction D1 may have a symmetrical shape based on a straight line perpendicular to the first direction D1, thereby allowing for smoother fluid flow. In one example, a first inclination direction of one end of the streamlined wall CW1 and a second inclination direction of one end of the streamlined wall CW2 adjacent to the one end of the streamlined wall CW1, with respect to the first direction, may be bent with each other. That is, the one end of the streamlined wall CW1 and the one end of the streamlined wall CW2, which are adjacent to each other, may not extend in the same direction. In one example, the one end of the streamlined wall CW1 and the one end of the streamlined wall CW2, which are adjacent to each other, may extend in directions in the first and fourth quadrants, respectively, in a coordinate system of the first direction and the second direction, or the one end of the streamlined wall CW1 and the one end of the streamlined wall CW2, which are adjacent to each other, may extend in directions in the second and third quadrants, respectively, in the coordinate system of the first direction and the second direction.

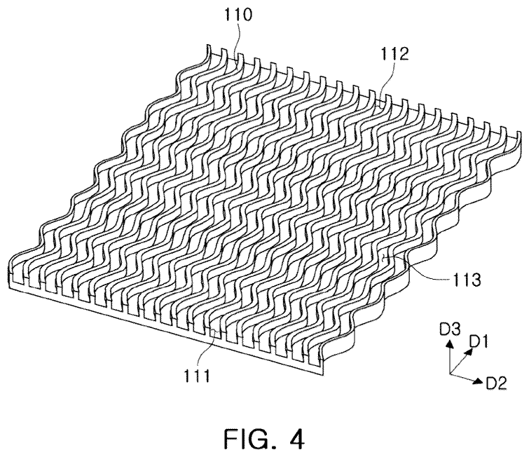

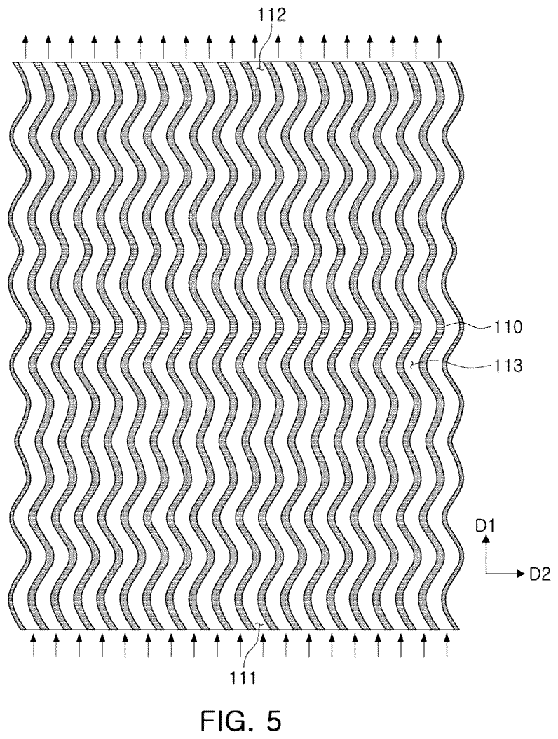

Meanwhile, unlike the above-described example embodiment, the streamlined wall 110 may be implemented in a shape in which the streamlined walls 110 extend integrally from the fluid inlet 111 to the fluid outlet 112 in the first direction D1. When this is described with reference to FIGS. 4 and 5, FIGS. 4 and 5 schematically illustrate an appearance of a separator for an electrochemical device according to a modified example embodiment and correspond to a perspective view and a plan view, respectively. As in this modified example embodiment, the streamlined wall 110 may extend integrally from the fluid inlet 111 to the fluid outlet 112 in the first direction D1 instead of being divided into a plurality of pieces. Additionally, the streamlined wall 110 may be provided in plural and the plurality of the streamlined walls 110 may be arranged in the second direction D2.

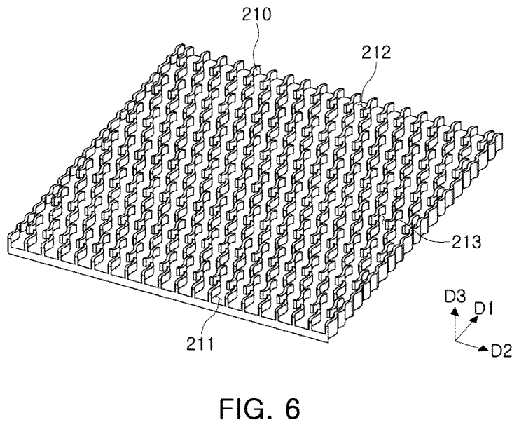

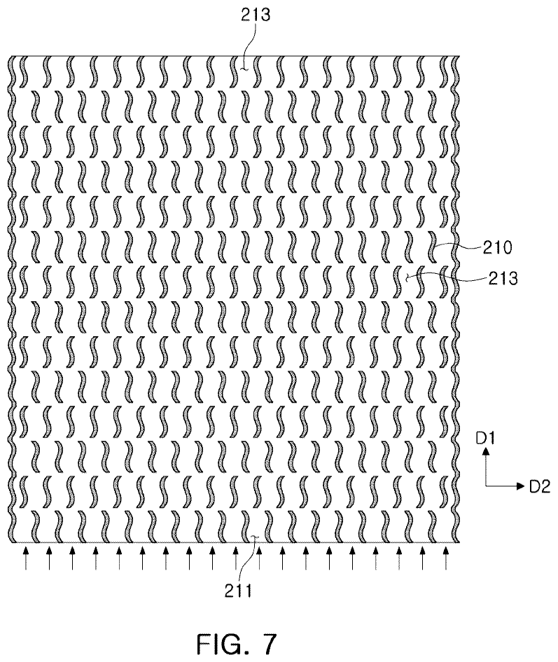

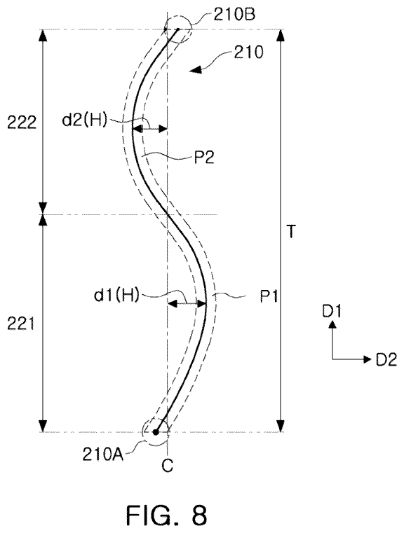

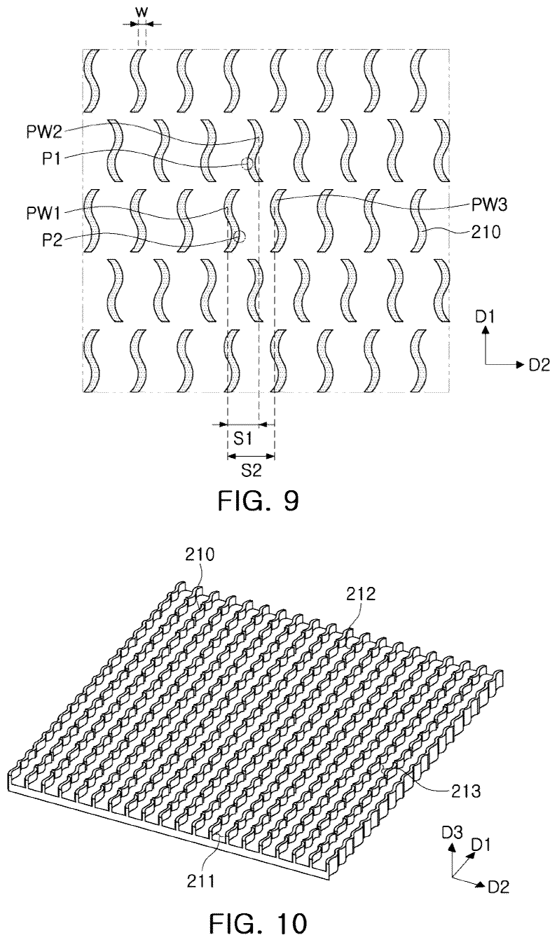

FIGS. 6 and 7 schematically illustrate an appearance of a separator for an electrochemical device according to another example embodiment of the present disclosure and correspond to a perspective view and a plan view, respectively. Additionally, FIG. 8 illustrates an enlarged view of a partial region in FIG. 7, and FIG. 9 is an enlarged view of the streamlined wall in FIG. 7.

Referring to FIGS. 6 and 7, similarly to the previous example embodiment, the separator 200 includes a fluid inlet 211 and a fluid outlet 212, and the streamlined wall 210 forms at least a portion of the flow path 213 connected to the fluid inlet 211 and the fluid outlet 212. As illustrated in FIG. 8, one end 210A and the other end 210B of the streamlined wall 210 may be disposed in opposite positions based on the central axis C. In the case of this example embodiment, the streamlined wall 210 includes one first streamlined portion 221 and one second streamlined portion 222. A length in the first direction D1 is relatively shorter than that of the previous example embodiment, and the streamlined wall 110 of the previous example embodiment may be referred to as a channel-shaped streamlined wall, and the streamlined wall 210 of this example embodiment may also be referred to as a pattern-shaped streamlined wall. In this case, as illustrated, an outermost region of the separator 200 (leftmost and rightmost walls based on the drawing) may also have a streamlined structure to correspond to the streamlined wall 210. Referring to FIG. 6 and describing the shape of the streamlined wall 210, when a sum of a length of the first streamlined portion 221 and a length of the second streamlined portion 222 adjacent thereto based on the length in the first direction D1 is referred to as T, and a maximum length of the first protrusion portion P1 or the second protrusion portion P2 spaced apart from the central axis C in the second direction D2 is referred to as H, a condition of 2.5≤T/H≤4 may be satisfied. Here, T may be equal to a length of the streamlined wall 210 in the first direction D1. When the condition of 2.5≤T/H≤4 is satisfied, this corresponds to a case in which the lengths d1 and d2 of the protrusion portions P1 and P2 are relatively longer than that of a typical sine wave.

As illustrated, the pattern-shaped streamlined wall 210 may be provided in plural, and the plurality of streamlined walls 210 may be arranged in the first direction D1 and the second direction D2. In this case, referring to FIG. 9, streamlined walls PW1 and PW2 adjacent to each other in the first direction D1, among the plurality of streamlined walls 210, may be disposed in positions shifted in the second direction D2, that is, may be spaced apart from each other diagonally based on FIG. 9. As a more specific example, when a length of the streamlined walls PW1 and PW2, in the second direction D2, adjacent to each other in the first direction D1, among the plurality of streamlined walls 210, is referred to as S1, and a length of the streamlined walls PW1 and PW3, in the second direction D2, adjacent to each other in the second direction D2, among the plurality of streamlined walls 210, is referred to as S2, a condition 0.4≤S1/S2≤0.6 may be satisfied. Additionally, in the streamlined walls PW1 and PW2 adjacent to each other in the first direction D1 and disposed in positions shifted in the second direction D2, among the plurality of streamlined walls 210, directions in which the first protrusion portion P1 protrudes may be opposite to each other based on the central axis C. In other words, when the streamlined walls PW1 and PW2 adjacent to each other in the first direction D1 and disposed in positions shifted in the second direction D2 are disposed on the same level based on the first direction D1, the streamlined walls PW1 and PW2 may form an axisymmetric structure that is symmetrical with respect to the central axis C. Since the pattern-shaped streamlined wall 210 has relatively low density of the streamlined wall 210, the flow of fluid may be preferably divided by arranging the streamlined walls 210 in the diagonal direction as described above, and further, the separator 200 may, preferably, meet the above-described length conditions and have a symmetrical structure in order to have a uniform current density.

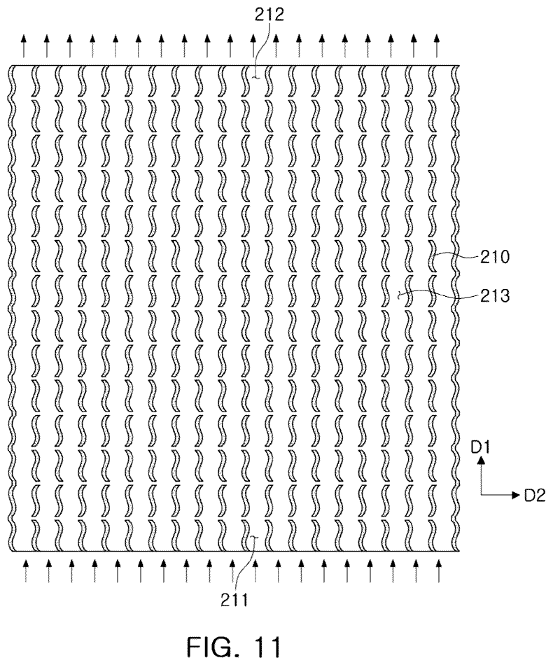

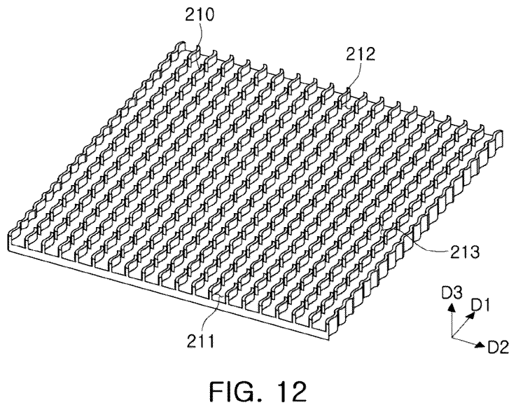

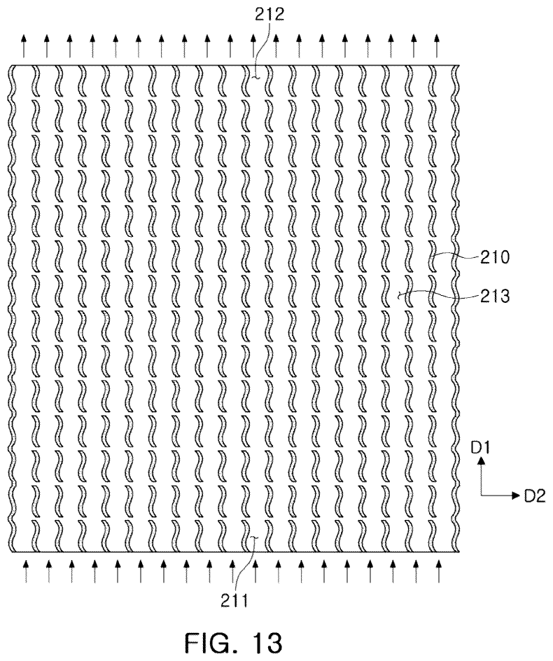

The above-described example embodiment of FIG. 6 may be modified and will be described with reference to FIGS. 10 to 13. First, FIGS. 10 and 11 schematically illustrate an appearance of a separator for an electrochemical device according to a modified example embodiment and correspond to a perspective view and a plan view, respectively. As illustrated in FIGS. 10 and 11, streamlined walls 210 adjacent to each other in the first direction D1 may not be arranged to be spaced apart from each other in a diagonal direction but may be arranged to be spaced apart from each other in the first direction D1. In this case, the streamlined walls 210 adjacent to each other in the first direction D1 may form a symmetrical structure with respect to a straight line, parallel to the second direction D1. Next, FIGS. 12 and 13 schematically illustrate an appearance of a separator for an electrochemical device according to a modified embodiment and correspond to a perspective view and a plan view, respectively. As illustrated in FIGS. 12 and 13, the streamlined walls 210 adjacent to each other in the first direction D1 may not be arranged to be spaced apart from each other in the diagonal direction but may be arranged to be spaced apart from each other in the first direction D1. However, as an arrangement method different from that of an example embodiment of FIGS. 10 and 11, the streamlined walls 210 adjacent to each other in the first direction D1 may be arranged in the same shape in the first direction D1 rather than forming a symmetrical structure.

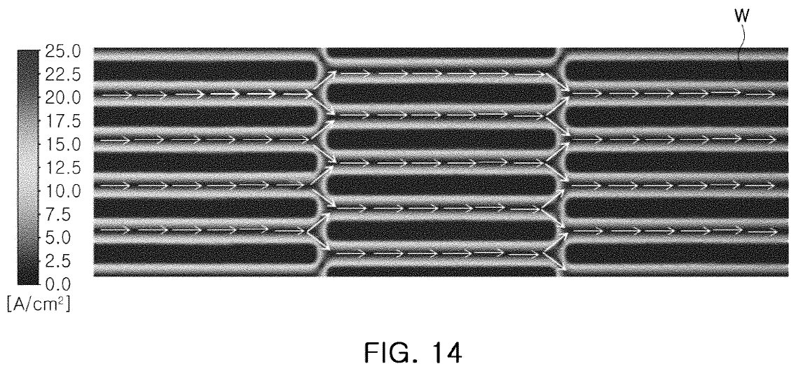

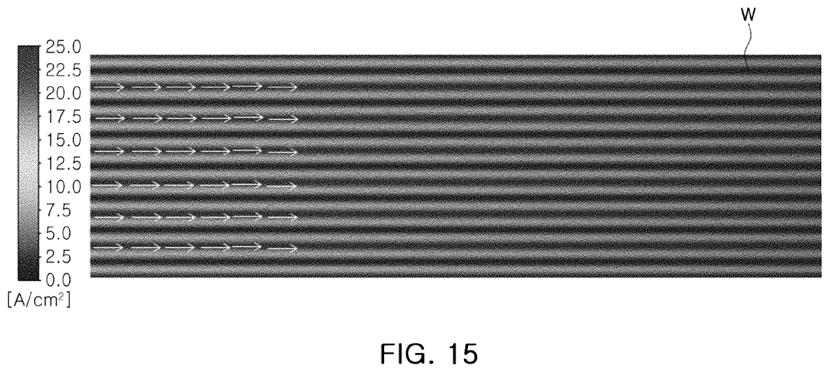

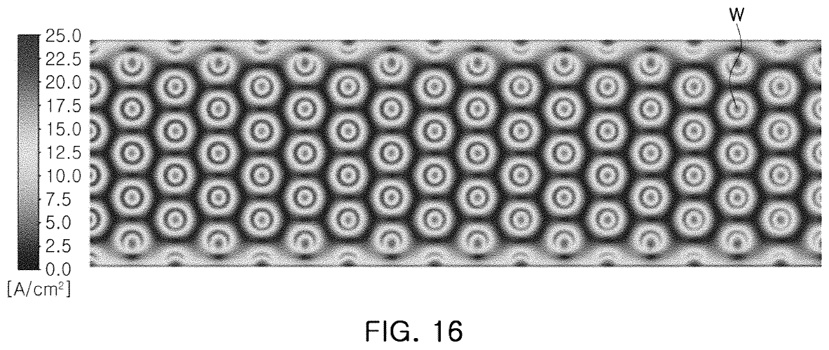

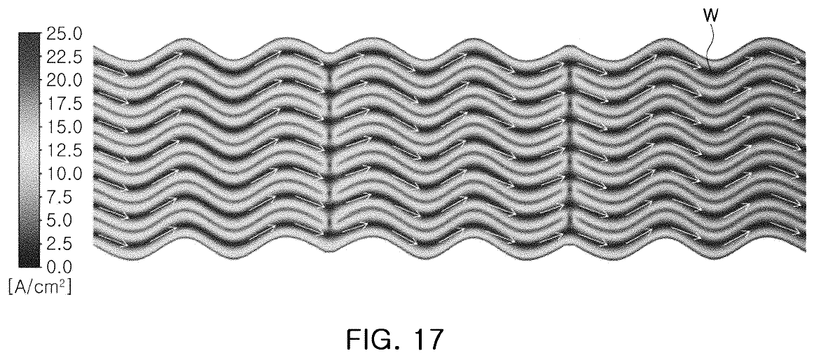

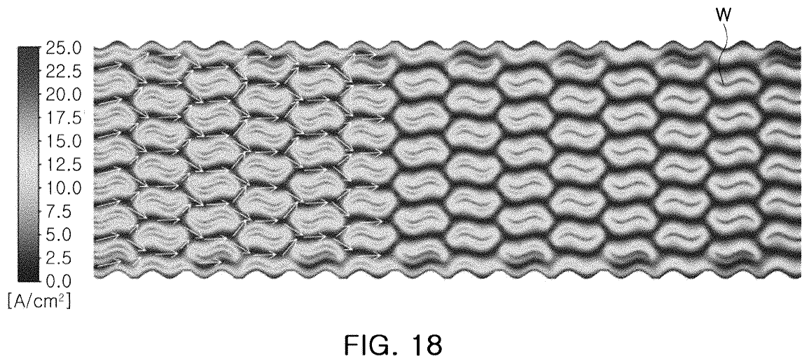

Referring to FIGS. 14 to 20, results of comparing characteristics according to a shape of a flow path of a separator will be described. First, FIGS. 14 to 18 illustrate results of analyzing the distribution of sizes of current density using a Computational Fluid Dynamics (CFD) model according to the shape of a wall forming the flow path in the separator. Here, FIG. 14 illustrates analysis results for a separator including a stripe-shaped wall W, FIG. 15 illustrates analysis results for a separator including a straight wall W, FIG. 16 illustrates analysis results for a separator including a cylindrical wall W. Additionally, FIGS. 17 and 18 illustrate analysis results for a separator including the streamlined wall W according to the example embodiment of FIGS. 1 and 6, respectively. In the case of the stripe-shaped wall W in FIG. 14 and the straight wall W in FIG. 15, an area occupied by the flow path is relatively small, and based on the plan view from an upper portion, the area of the flow path is about 50% of an entire separator. Conversely, an area occupied by the wall W is relatively large, and accordingly, electrical resistance between electrodes of an electrochemical cell or between a current collector and the separator may increase. This resulted in low intensity of chemical reaction and uneven current density in an entire region of the separator. Additionally, in the case of the cylindrical wall W of FIG. 16, the current density was concentrated around the wall W, which may make it unsuitable for improving the performance of electrochemical devices. In comparison, in the case of separators according to an example embodiment of the present disclosure, on the whole, the current density was uniform and the flow of fluid and current was smooth.

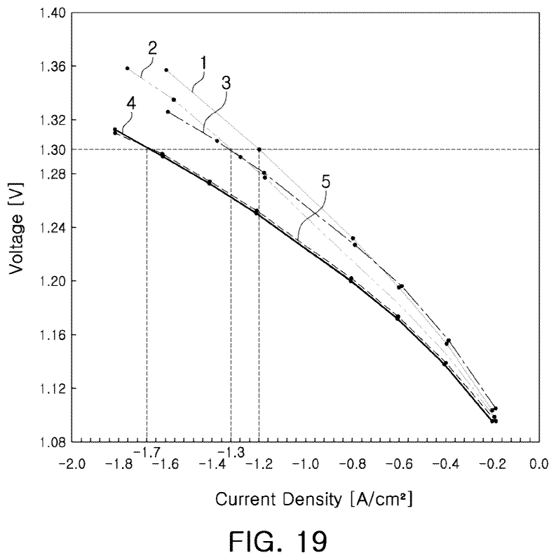

Next, FIG. 19 is result of analyzing a relationship between cell voltage and current density for the various types of walls described above. Referring to a graph in FIG. 19, when a channel-shaped streamlined wall (No. 4) and a pattern-shaped streamlined wall (No. 5) as in the example embodiment of the present disclosure are used as compared to a case of using a stripe-shaped wall (No. 1), a straight wall (No. 2), or a cylindrical wall (No. 3), a magnitude of the current density in the example embodiment is higher at the same voltage. For example, in the case of current density at Thermo-Neutral Voltage 1.3V, the current density of the channel-shaped streamlined wall (No. 4) and the pattern-shaped streamlined wall (No. 5) was approximately 27% higher than when using the existing wall.

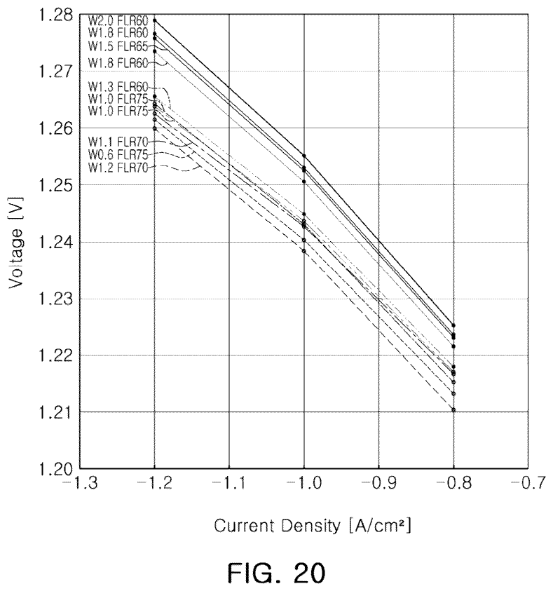

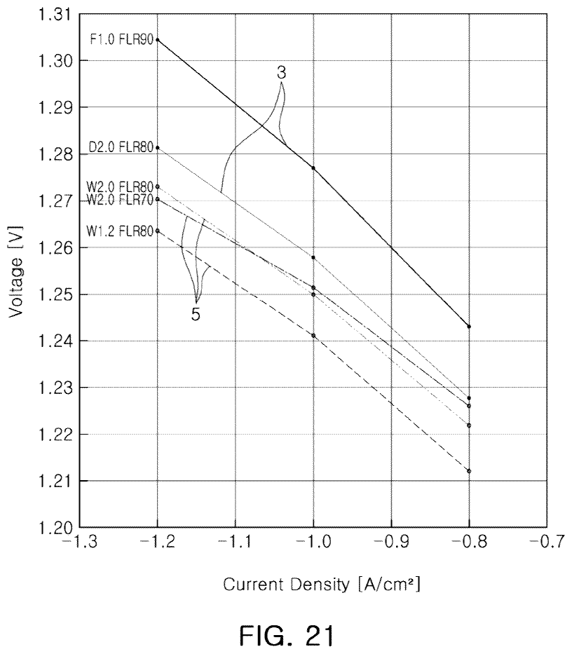

A graph in FIG. 20 analyzes a relationship between cell voltage and current density by varying a width w of the streamlined wall and a flow land ratio (FLR) in the separator according to the example embodiment of FIG. 1. Here, the width w of the streamlined wall and the flow path ratio (FLR) may be determined based on a plan view viewed from the upper portion, as illustrated in FIG. 2, and the width w of the streamlined wall may be defined as a length in the second direction, and the flow path ratio (FLR) may be defined as a percentage (%) of an area of a flow path to a total area of the separator. In this case, in FIG. 20, W1.0 denotes that the width w of the streamlined wall is 1.0 mm, and FLR70 denotes that the flow path ratio is 70%. As the flow path ratio increases, the area of the wall decreases, and so that contact resistance between the separator and the electrode or the current collector of the electrochemical cell may decrease. Accordingly, an overall electrical resistance value of the electrochemical device may decrease and the current density may increase. Additionally, the graph in FIG. 21 analyzes a relationship between cell voltage and current density by varying the width w of the streamlined wall (No. 5) and the flow path ratio in the separator according to the example embodiment of FIG. 6, and further illustrates comparison results according to the diameter and the flow path ratio in the case of the cylindrical wall (No. 3). The pattern-shaped streamlined wall and the cylindrical wall may be implemented by applying a stamping process to a metal plate.

Referring to the analysis results of FIGS. 20 and 21, in a case in which the streamlined wall as in the example embodiment of FIGS. 1 and 6 is adopted, based on the flow path ratio (FLR), that is, the shape viewed from the upper portion, relatively high performance is exhibited when the area occupied by the flow path is 70 to 80% of the total area, and in this case, a contact area between the fluid and the streamlined wall may be sufficiently large and the current may flow smoothly through the streamlined wall. However, when the width w of the streamlined wall becomes significantly thin, performance may deteriorate, which is understood to be due to limited current flow.

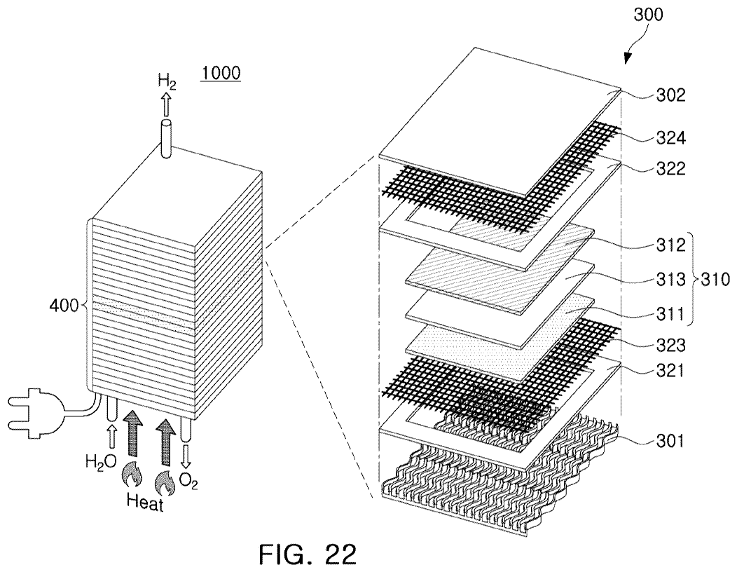

An example of applying the separator described above to an electrochemical device will be described with reference to FIG. 22. FIG. 22 illustrates a water electrolysis device to which a separator having a streamlined wall is applied. However, the above-described type of separator may be applied to other types of electrochemical devices, such as fuel cells, rather than water electrolysis devices. Referring to FIG. 22, the water electrolysis device 1000 includes a plurality of separators 301 and 302 and an electrochemical cell 310 disposed therebetween. Water in the form of water vapor is supplied as fuel to the water electrolysis device 1000, and the water may be electrolyzed and separated into hydrogen and oxygen. In order to improve the function of the water electrolysis device 1000, a plurality of units 300 including the separators 301 and 302 and the electrochemical cell 310 are provided and repeated to form a stack body 400. Observing components of the unit 300, the unit 300 may include a separator 301 at a fuel electrode and a separator 302 at an air electrode, and in this case, the separator 301 at the fuel electrode is implemented in a form including the plurality of streamlined walls as described above, thus improving the performance of the water electrolysis device 1000. In FIG. 22, the separator according to the example embodiment of FIG. 1 was used, but separators according to other embodiments, such as the separator illustrated in FIG. 6, may also be adopted. Additionally, the shape of the separator 302 at the air electrode is not limited, and a conventional separator having a straight wall may be used. However, the separator 302 at the air electrode, which has the same shape as the separator 301 at the fuel electrode, also includes a streamlined wall, so that a smooth flow of fluid may be induced in the air electrode as well.

For the electrochemical cell 310, as an example, a solid oxide cell may be used. Specifically, the electrochemical cell 310 may include a fuel electrode 311, an air electrode 312, and an electrolyte 313 disposed therebetween. Here, the fuel electrode 311 may include a cermet layer including a metal-containing phase and a ceramic phase. Here, the metal-containing phase may include a metal catalyst such as nickel (Ni), cobalt (Co), copper (Cu), or alloys thereof, which acts as an electronic conductor. The metal catalyst may be in a metallic state or may be in an oxide state. The ceramic phase of the anode 311 may include gadolinia doping seria (gdc), samaria doping seria (sdc), yterbia doping seria (ydc), scandia stabilized zirconia (ssz), and ytterbia ceria scandia stabilized zirconia (ybcssz). The air electrode 312 may include an electrically conductive material, like an electrically conductive perovskite material such as lanthanum strontium manganite (LSM). Other conducting perovskites, metals such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}Ni_{0.1}O₃ (LSCN) or Pt may also be used. In some example embodiments, the air electrode 312 may include a mixture of an electrically conductive material and an ionically conductive ceramic material. For example, the air electrode 123 may include about 10 wt % to about 90 wt % of the electrically conductive material (e.g., LSM, etc.) and about 10 wt % to about 90 wt % of the ionically conductive material. Here, the ionically conductive material may include zirconia-based and/or ceria-based materials. The electrolyte 313 may include stabilized zirconia. Specifically, the electrolyte 313 may include scandia stabilized zirconia (ssz), yttria stabilized zirconia (ysz), scandia ceria stabilized zirconia (scsz), scandia ceria yttria stabilized zirconia (scysz), and scandia ceria yterbia stabilized zirconia (scybsz).

Meanwhile, the case in which the electrochemical cell 310 is the solid oxide cell has been described above, but the electrochemical cell 310 may also adopt a polymer electrolyte membrane cell.

Gaskets 321 and 322 may be disposed on the outside of the electrochemical cell 310 between the separators 301 and 302 to prevent fluid from leaking to the outside. Additionally, current collection layers 323 and 324 may be disposed between the separators 301 and 302 and the electrochemical cell 310. The current collection layers 323 and 324 may preferably have excellent oxidation resistance to maintain excellent electrical conductivity. Additionally, as illustrated, the current collection layers 323 and 324 may have a porous structure such as a net structure to allow fluid to pass therethrough.

The present disclosure is not limited by the above-described example embodiments and attached drawings, but is limited by the attached claims. Accordingly, it will be understood by those skilled in the art that various substitutions, modification and changes in form and details may be made therein without departing from the spirit and scope of the present disclosure as defined by the appended claims, and these substitutions, modifications, or changes should be construed as being included in the scope of the present disclosure.

What is claimed is:

1. A separator for an electrochemical device, comprising:
a fluid inlet;
a fluid outlet; and
a plurality of streamlined walls configured to provide at least a portion of a flow path connected to the fluid inlet and the fluid outlet,
wherein at least two of the plurality of streamlined walls, including one streamlined wall closer to the fluid inlet than another streamline wall, have a shape in which straight lines connecting one end and the other end are not parallel to each other.

2. The separator for an electrochemical device according to claim 1, wherein when a direction oriented from the fluid inlet to the fluid outlet is referred to as a first direction, and a direction, perpendicular to the first direction, is referred to as a second direction,
at least one of the plurality of streamlined walls includes a first streamlined portion having a central axis, parallel to the first direction, and having a first protrusion portion protruding in the second direction, based on the central axis, and a second streamlined portion connected to the first streamlined portion and having a second protrusion protruding in the second direction, based on the central axis.

3. The separator for an electrochemical device according to claim 2, wherein one end and the other end of the at least one streamlined wall are disposed in opposite positions based on the central axis.

4. The separator for an electrochemical device according to claim 2, wherein the first and second protrusion portions protrude in opposite directions with respect to the central axis.

5. The separator for an electrochemical device according to claim 4, wherein the first and second protrusion portions have the same maximum length spaced apart from the central axis in the second direction.

6. The separator for an electrochemical device according to claim 2, wherein at least one of one end and the other end of the at least one streamlined wall has an angle of 30° or less, with respect to the first direction.

7. The separator for an electrochemical device according to claim 2, wherein the at least one streamlined wall includes each of the first and second streamlined portions in plural and has a structure in which the first streamlined portions and the second streamlined portions are alternately repeated.

8. The separator for an electrochemical device according to claim 7, wherein the at least one streamlined wall includes two each of the first streamlined portion and the second streamlined portion.

9. The separator for an electrochemical device according to claim 7, wherein when a sum of a length of the first streamlined portion and a length of the second streamlined portion adjacent thereto based on a length in the first direction is referred to as T and a maximum length in the second direction in which the first protrusion portion or the second protrusion portion is spaced apart from the central axis is referred to as H,
a condition of 8≤T/H≤12 is satisfied.

10. The separator for an electrochemical device according to claim 1, wherein when a direction oriented from the fluid inlet to the fluid outlet is referred to as a first direction,
the plurality of streamlined walls are arranged in the first direction.

11. The separator for an electrochemical device according to claim 10, wherein among the plurality of streamlined walls, streamlined walls adjacent to each other in the first direction have a symmetrical shape based on a straight line, perpendicular to the first direction.

12. The separator for an electrochemical device according to claim 1, wherein when a direction oriented from the fluid inlet to the fluid outlet is referred to as a first direction, and a direction, perpendicular to the first direction, is referred to as a second direction,
the plurality of streamlined walls are arranged in the second direction.

13. The separator for an electrochemical device according to claim 1, wherein based on a shape viewed from an upper portion, an area occupied by the flow path is 70 to 80% of a total area.

14. The separator for an electrochemical device according to claim 2, wherein the at least one streamlined wall includes one each of the first streamlined portion and the second streamlined portion.

15. The separator for an electrochemical device according to claim 14, wherein when a sum of a length of the first streamlined portion and a length of the second streamlined portion adjacent thereto based on a length in the first direction is referred to as T and a maximum length in the second direction in which the first protrusion portion or the second protrusion portion is spaced apart from the central axis is referred to as H,
a condition of 2.5 <T/H≤4 is satisfied.

16. The separator for an electrochemical device according to claim 14, wherein the plurality of streamlined walls are arranged in the first and second directions.

17. The separator for an electrochemical device according to claim 16, wherein among the plurality of streamlined walls, streamlined walls adjacent to each other in the first direction are disposed in positions shifted in the second direction.

18. The separator for an electrochemical device according to claim 17, wherein when a second directional length of the streamlined walls adjacent to each other in the first direction, among the plurality of streamlined walls, is referred to as S1 and a second directional length of streamlined walls adjacent to each other in the second direction, among the plurality of streamlined walls, is referred to as S2,
a condition of 0.4≤S1/S2≤0.6 is satisfied.

19. The separator for an electrochemical device according to claim 17, wherein in streamlined walls adjacent to each other in the first direction and disposed in positions shifted in the second direction, among the plurality of streamlined walls, directions in which the first protrusion portion protrudes are opposite to each other based on the central axis.

20. A separator for an electrochemical device, comprising:
a fluid inlet;
a fluid outlet; and
a plurality of streamlined walls configured to provide at least a portion of a flow path connected to the fluid inlet and the fluid outlet,
wherein when a direction oriented from the fluid inlet to the fluid outlet is referred to as a first direction, and a direction, perpendicular to the first direction, is referred to as a second direction,
at least one of the plurality of streamlined walls has a shape in which a straight line connecting one end and the other end is not parallel to the first direction.

21. The separator for an electrochemical device according to claim 20, wherein the at least one streamlined wall includes a first streamlined portion having a central axis, parallel to the first direction, and having a first protrusion portion protruding in the second direction, based on the central axis, and a second streamlined portion connected to the first streamlined portion and having a second protrusion portion protruding in the second direction, based on the central axis.

22. The separator for an electrochemical device according to claim 21, wherein the one end and the other end of the at least one streamlined wall are disposed in opposite positions based on the central axis.

23. The separator for an electrochemical device according to claim 21, wherein the first and second protrusion portions protrude in opposite directions based on the central axis.

24. The separator for an electrochemical device according to claim 23, wherein the first and second protrusion portions have the same maximum length spaced apart from the central axis in the second direction.

25. The separator for an electrochemical device according to claim 21, wherein at least one of the one end and the other end of the at least one streamlined wall has an angle of 30° or less, with respect to the first direction.

26. The separator for an electrochemical device according to claim 21, wherein the at least one streamlined wall includes each of the first and second streamlined portions in plural and has a structure in which the first streamlined portions and the second streamlined portions are alternately repeated.

27. The separator for an electrochemical device according to claim 26, wherein the at least one streamlined wall includes two each of the first streamlined portion and the second streamlined portion.

28. The separator for an electrochemical device according to claim 26, wherein when a sum of a length of the first streamlined portion and a length of the second streamlined portion adjacent thereto based on a length in the first direction is referred to as T and a maximum length in the second direction in which the first protrusion portion or the second protrusion portion is spaced apart from the central axis is referred to as H,
a condition of 8≤T/H≤12 is satisfied.

29. The separator for an electrochemical device according to claim 20, wherein the plurality of streamlined walls are arranged in the first direction.

30. The separator for an electrochemical device according to claim 29, wherein among the plurality of streamlined walls, streamlined walls adjacent to each other in the first direction have a symmetrical shape based on a straight line, perpendicular to the first direction.

31. The separator for an electrochemical device according to claim 20, wherein the plurality of streamlined walls are arranged in the second direction.

32. The separator for an electrochemical device according to claim 20, wherein based on a shape viewed from an upper portion, an area occupied by the flow path is 70 to 80% of a total area.

33. The separator for an electrochemical device according to claim 21, wherein the at least one streamlined wall includes one each of the first streamlined portion and the second streamlined portion.

34. The separator for an electrochemical device according to claim 33, wherein when a sum of a length of the first streamlined portion and a length of the second streamlined portion adjacent thereto based on a length in the first direction is referred to as T and a maximum length in the second direction in which the first protrusion portion or the second protrusion portion is spaced apart from the central axis is referred to as H,
a condition of 2.5 ≤T/H≤4 is satisfied.

35. The separator for an electrochemical device according to claim 33, wherein the plurality of streamlined walls are arranged in the first and second directions.

36. The separator for an electrochemical device according to claim 35, wherein among the plurality of streamlined walls, streamlined walls adjacent to each other in the first direction are disposed in positions shifted in the second direction.

37. The separator for an electrochemical device according to claim 36, wherein when a second directional length of the streamlined walls adjacent to each other in the first direction, among the plurality of streamlined walls, is referred to as S1 and a second directional length of streamlined walls adjacent to each other in the second direction, among the plurality of streamlined walls, is referred to as S2,
a condition of 0.4≤S1/S2≤0.6 is satisfied.

38. The separator for an electrochemical device according to claim 36, wherein in streamlined walls adjacent to each other in the first direction and disposed in positions shifted in the second direction, among the plurality of streamlined walls, directions in which the first protrusion portion protrudes are opposite to each other based on the central axis.

39. An electrochemical device, comprising:
a plurality of separators; and
an electrochemical cell disposed between the plurality of separators,
wherein at least one of the plurality of separators includes a fluid inlet, a fluid outlet, and a plurality of streamlined walls configured to provide at least a portion of a flow path connected to the fluid inlet and the fluid outlet, and
at least two of the plurality of streamlined walls, including one streamlined wall closer to the fluid inlet than another streamline wall, have a shape in which straight lines connecting one end and the other end are not parallel to each other.

40. The electrochemical device according to claim 39, further comprising:
a current collector disposed between at least one of the plurality of separators and the electrochemical cell.

41. A separator for an electrochemical device, comprising:
a fluid inlet;
a fluid outlet spaced apart from the fluid inlet in a first direction; and
a plurality of streamlined walls disposed in a region between the fluid inlet and the fluid outlet,
wherein a first distance in the first direction from a first streamlined wall among the plurality of streamlined walls to one of the fluid inlet and the fluid outlet is different from a second distance in the first direction from a second streamlined wall among the plurality of streamlined walls to the one of the fluid inlet and the fluid outlet, and
a first inclination direction of one end of the first streamlined wall and a second inclination direction of one end of the second streamlined wall adjacent to the one end of the first streamlined wall, with respect to the first direction, are bent with each other.

42. The separator for an electrochemical device according to claim 41, wherein the first streamlined wall includes a first streamlined portion having a first protrusion portion protruding in a second direction and a second streamlined portion connected to the first streamlined portion and having a second protrusion protruding in the second direction, the second direction being perpendicular to the first direction.

43. The separator for an electrochemical device according to claim 42, wherein the first and second protrusion portions protrude in opposite directions with respect to the first direction.

44. The separator for an electrochemical device according to claim 42, wherein the first streamlined wall includes each of the first and second streamlined portions in plural and has a structure in which the first streamlined portions and the second streamlined portions are alternately repeated.

45. The separator for an electrochemical device according to claim 41, wherein the one end of the first streamlined wall and the end of the second streamlined wall adjacent to the one end of the first streamlined wall are aligned in the first direction.

46. The separator for an electrochemical device according to claim 41, wherein the one end of the first streamlined wall and the end of the second streamlined wall adjacent to the one end of the first streamlined wall are offset in the first direction.

47. An electrochemical device, comprising:
a plurality of separators; and
an electrochemical cell disposed between the plurality of separators,
wherein at least one of the plurality of separators includes a fluid inlet, a fluid outlet spaced apart from the fluid inlet in a first direction, and a plurality of streamlined walls disposed in a region between the fluid inlet and the fluid outlet,
a first distance in the first direction from a first streamlined wall among the plurality of streamlined walls to one of the fluid inlet and the fluid outlet is different from a second distance in the first direction from a second streamlined wall among the plurality of streamlined walls to the one of the fluid inlet and the fluid outlet, and
a first inclination direction of one end of the first streamlined wall and a second inclination direction of one end of the second streamlined wall adjacent to the one end of the first streamlined wall, with respect to the first direction, are bent with each other.

48. The electrochemical device according to claim 47, further comprising:
a current collector disposed between at least one of the plurality of separators and the electrochemical cell.
